(19) United States
(12) Patent Application Publication
(10) Pub. No.: US 2017/0373504 A1
(43) Pub. Date: Dec. 28, 2017

(54) SYSTEM AND METHOD FOR SELF-REGULATION ELECTRIC POWER OF THE GAS REFILL CENTER

(71) Applicant: ECOPLUS CO.,LTD., Daejeon (KR)

(72) Inventors: Jong-Ho WOO, Daejeon (KR); Ho-Seok CHOI, Daejeon (KR)

(73) Assignee: ECOPLUS CO.,LTD., Daejeon (KR)

(21) Appl. No.: 15/370,348

(22) Filed: Dec. 6, 2016

(30) Foreign Application Priority Data
Jun. 28, 2016 (KR) 10-2016-0080938

(51) Int. Cl. H02J 3/46; G05B 15/02; H02J 3/00

(52) U.S. Cl. CPC H02J 3/46; G05B 15/02; H02J 2003/007

(57) ABSTRACT

Disclosed herein are a system and method for efficient regulation of electric power of a gas refill center capable of enabling efficient operation of a natural gas generator and electric power storage means provided to the gas refill center while reducing electric utility charges by reducing the power consumption amount and the peak electric power produced by operation of a compressor of a high load device using the natural gas generator and the power storage means.

### BACKGROUND OF THE INVENTION

### Field of the Invention

The present invention relates to a power system, and more particularly, to a system and method for efficient regulation of electric power of a gas refill center capable of enabling efficient operation of a natural gas generator and electric power storage means provided to the gas refill center while reducing electric utility charges by reducing the power consumption amount and the peak electric power produced by start-up and operation of a high load device using the natural gas generator and the power storage means.

### Description of the Related Art

Commercially available power is usually produced by power plants and distributed to factories, buildings, homes, etc. through pole transformers and switchboards after the power passes through substations via the power transmission lines.

The supply of such public electricity, which is a public service that provides essential services for living, is a core industry supplying power to industries. Further, since public electricity is produced/supplied through large-scale power generation facilities, the supply of public electricity is made by a natural monopoly that is allowed for exclusive local supply. Given the nature of the electricity service, electricity rates are determined by public policy and regulations.

In this regard, due to the characteristics of electric power facilities, it is impossible to store all produced electricity, and thus electric power is produced and consumed simultaneously. Therefore, to ensure stable supply of electric power, electric power facilities are always provided based on the maximum demand time during which electric use is concentrated during the day.

In addition, part of the power facilities becomes idle in times of low electricity use. In order to optimize the utilization of electric power facilities through leveling of electric power load devices, the ‘peak time charge’ based on the marginal cost principle has been adopted for electric power exceeding the contracted maximum industrial power, at which the electric power load device is adjustable. Thereby, the highest charge rate is applied in the most demanding hours of electricity use, an average charge rate corresponding to production cost is applied during the hours of average electricity demand, and the lowest charge rate is applied during the low load hours during which electricity is least used. The charge amount is calculated by multiplying the hourly charge by the power usage. In addition, unit price, power factor amount, value added tax, and power industry-based fund based on the amount of contracted electricity are collectively reflected in the calculation of the charge amount.

The problem is that, when power is supplied to a large number of high-load devices at the same time, the total sum of peak powers (instantaneous values) of all the devices suddenly increases, and thus the power consumption of the devices exceeds the contract power set as the power supply amount of the supply system, thereby raising costs.

In addition, it is essential to stabilize the power system so that the power consumption of the equipment held in the electric accommodation facility is always lower than the power supply amount of the supply system. Although the maximum peak value (instantaneous value) of all the power consuming equipment should not be summed at the same time, it is difficult to predict/manage the operation of the equipment, and thus it is inevitable to pay an excessive electricity fee.

### Prior Art Literature

### Patent Literature

Korean Patent Application Publication No. 10-2015-0003142 (Pub. Date: Aug. 1, 2015)

### SUMMARY OF THE INVENTION

Therefore, the present invention has been made in view of the above problems, and it is an object of the present invention to provide a system and method for efficient regulation of electric power of a gas refill center which are capable of reducing the amount of commercial power used and the peak of electric power by using the independently produced power and the stored power.

Other objects, advantages and new features will be apparent from the following detailed description and the preferred embodiments in association with the accompanying drawings.

In accordance with one aspect of the present invention, the above and other objects can be accomplished by the provision of a system for efficient regulation of electric power of a gas refill center, including a measurement unit for measuring a stored amount of the gas storage unit 110, a commercial power supply unit supplied with commercial power, a power generation unit for producing electric power through gas, a power storage unit for storing the produced power of the power generation unit, a plurality of load devices, a switching unit for selectively supplying the commercial power, the produced power of the power generation unit and the stored power of the power storage unit 140 to the load devices, a controller configured to control the power generation unit, the gas compressors and the switching unit, the controller controlling the power generation unit and the switching unit according to input power distribution information corresponding to the stored amount and power consumption of the load device.

The system may further include a power monitoring unit for monitoring the power consumption of the load device, the produced power of the power generation unit, and an amount of the stored power of the power storage unit, wherein the power generation unit may include an internal combustion engine generator for generating electric power by burning gas, a breaker for supplying the power generated by the generator to an outside, and a meter for calculating an amount of gas supplied to the generator, wherein the controller may include a power generation management unit 171 for analyzing a result of monitoring of the power monitoring unit to generate startup information for no-load driving of the generator and operation of the breaker and control the generator and the breaker according to the startup information.

The system may further include a gas monitoring unit for monitoring monitor an amount of gas supplied to the power generation unit and the stored amount and an amount of change of the gas storage unit, wherein the controller may include a gas management unit for generating sequential drive information on the plurality of gas compressors through analysis of the amount of change and sequentially operating the plurality of gas compressors according to the sequential drive information.

The controller may further include a first comparison unit for comparing the power consumption with the produced power of the power generation unit, a second comparison unit for comparing a current status of the power consumption with the stored power of the power storage unit, and an analysis unit for generating power distribution information to store surplus power in the power storage unit when the produced power of the power generation unit is larger than the power consumption and to supply the commercial power to the load device when the power consumption is larger than the stored power of the power storage unit.

The system may further include an operation monitoring unit for monitoring operation states of the power generation unit, the load device and the switching unit, a database for storing a capacity of the power storage unit, power consumption information on the load device, and power cost information according to a power usage pattern and time for operation of the load device, a simulation unit for calculating a power charge for each situation by reflecting the result of monitoring of the power monitoring unit, a result of monitoring of the operation monitoring unit and the stored information of the database.

The controller may further include an optimization unit for generating power distribution information by reflecting the power charge for each situation calculated by the simulation unit so as to minimize the power charge.

In accordance with another aspect of the present invention, the above and other objects can be accomplished by the provision of a method for efficient regulation of electric power of a gas refill center, including monitoring a stored amount of a gas storage unit, power consumption of a load device, a produced power of a power generation unit, and an amount of a stored power of a power storage unit, generating power distribution information corresponding to the stored amount and the power consumption of the load device, controlling the power generation unit according to the power distribution information, and selectively supplying a commercial power, the produced power of the power generation unit and the stored power of the power storage unit to the load device.

The controlling of the power generation unit may include generating startup information for no-load driving of the power generation unit and operation of a breaker by analyzing a result of the monitoring and controlling a generator and the breaker according to the startup information.

The monitoring may include monitoring an amount of gas supplied to the power generation unit, the stored amount and an amount of change of the gas storage unit, the method further including generating sequential drive information on a plurality of gas compressors through analysis of the amount of change and sequentially operating the plurality of gas compressors according to the sequential drive information.

The generating of the power distribution information may include comparing the power consumption with the produced power of the power generation unit, comparing a current status of the power consumption with the stored power of the power storage unit, and generating power distribution information to store surplus power in the power storage unit when the produced power of the power generation unit is larger than the power consumption and to supply the commercial power to the load device when the power consumption is larger than the stored power of the power storage unit.

The monitoring may include monitoring operation states of the power generation unit, the load device, and a switching unit, the method further including building a database through a capacity of the power storage unit, power consumption information on the load device, and power cost information according to a power usage pattern and time for operation of the load device, and calculating a power charge for each situation by reflecting a result of the monitoring and stored information of the database, wherein the generating of the power distribution information generating may include generating the power distribution information by reflecting the calculated power charge for each situation such that the power charge is minimized.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a configuration and a connection relationship according to a preferred embodiment of the present invention;

FIG. 2 is a block diagram illustrating a configuration and a connection relationship according to another embodiment of the present invention;

FIG. 3 is a flowchart illustrating a method for efficient regulation of electric power according to a preferred embodiment of the present invention;

FIG. 4 is a flowchart illustrating a method for efficient regulation of electric power according to another embodiment of the present invention;

FIG. 5 is a flowchart illustrating the step of generating power distribution information according to another embodiment of the present invention;

FIG. 6 is a graph depicting an example of a power usage trend of a gas refill center according to a unit time;

FIG. 7 is a graph depicting a power usage trend including 100% self-generated power;

FIG. 8 is a graph depicting a power usage trend due to economic self-power generation reflecting variations in the load; and

FIG. 9 is a graph depicting a trend of reduction in the amount of commercial power consumption according to application of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention, which is applicable to various industrial fields, is applied to a CNG gas refill center to achieve a large cost saving effect through efficient regulation of electric power. The gas refill center is a facility to store gas and charge gas to various mobile tanks as well as vehicles that use the same as fuel, has a plurality of gas compressors 151, which are high load devices 150, for transporting and storing the gas. The electric power charges are estimated to be high due to the excessive starting power and consumption amount resulting from the nature of the gas compressor load devices, and thus efficient management of electric power is required.

The gas compressor 151 is a typical load device that consumes the largest amount of power among the devices installed in a gas refill center. The start/stop of a single gas compressor device or the start/stop of multiple gas compressors occasionally occurs in order to maintain a discharge pressure range of 200 to 250 bar of the natural gas storage container before charging a vehicle which uses natural gas as fuel. The load device 150 referred to in the present invention substantially refers to the gas compressor 151 but may also encompass various devices that consume power.

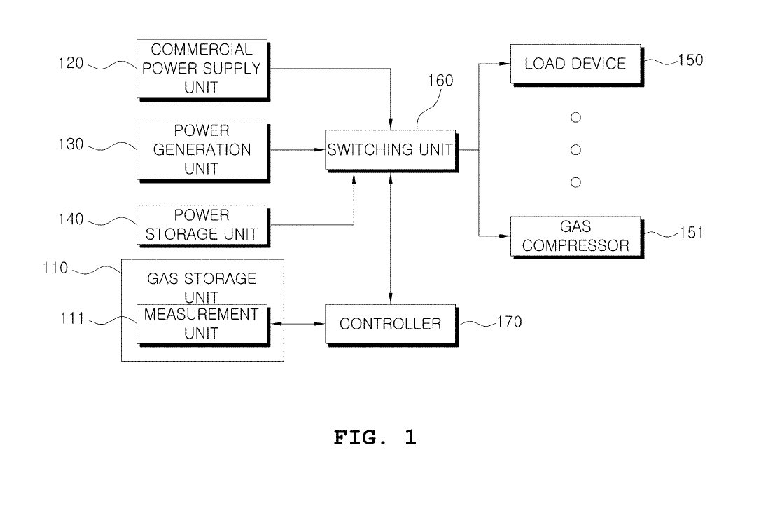

FIG. 1 is a block diagram illustrating a configuration and connection relationship according to a preferred embodiment of the present invention. The present invention basically includes a measurement unit 111, a commercial power supply unit 120, a power generation unit 130, a power storage unit 140, a switching unit 160, and a controller 170.

The measurement unit 111 corresponds to a pressure sensor for measuring the amount of gas stored in the gas storage unit 110 provided in the gas refill center, namely, the gas storage tank. The measuring unit 111 is intended for a storage tank that is responsible for supplying gas to a place demanding the gas, among various storage tanks.

As described above, regarding the operation of the gas compressor 151 in the normal gas storage, variation, particularly, decrease in the storage amount of the gas storage unit 110, triggers a signal to operate the gas compressor 151. In the present invention, this variation is collected as important information.

The commercial power supply unit 120 is configured to receive commercial power. Commercial power, which is electric power supplied from an electric power company, is sold based on contract price and usage amount. The commercial electric power is basically used as a power source in most industries.

The power generation unit 130 is provided in a gas refill center and includes a generator that generates electric power. The power generation unit 130 is provided at a site where stable power supply is important. The power generation unit 130 is driven as needed to replace the commercial power or to be supplied together with the commercial power. As the present invention is applied to the gas refill center, gas is used as fuel for driving the power generation unit 130.

The power storage unit 140 is an energy storage system (ESS) for storing the power produced by the power generation unit 130. That is, the power storage unit 140 is a storage means to store the electric power over-produced by the power generation unit 130 and supply the stored electric power to the load devices 150 when necessary. The power storage unit 140 includes a battery that stores electricity and related devices that efficiently manage the battery. As the alternating current (AC) power is produced by the power generation unit 130, the AC power is converted into a direct current (DC) power and stored, and the stored DC power is converted into an AC current to supply the stored DC power to the load. To this end, a conversion circuit is provided.

The switching unit 160 is a kind of switch that is electronically driven and is positioned between the commercial power supply unit 120, the power generation unit 130, the power storage unit 140 and the load device 150. Thereby, the switching unit 160 allows the commercial power, the power produced by the power generation unit 130, and the power stored in the power storage unit 140 to be selectively supplied to the load unit 150. In some cases, the switching unit 160 allows some or all of the power produced by the power generation unit 130 to be supplied to and stored in the power storage unit 140.

The controller 170 basically controls the commercial power supply unit 120, the power generation unit 130, the power storage unit 140, the gas compressor 151, namely, the load device 150, and the switching unit 160. In particular, the controller 170 controls the power generation unit 130 and the switching unit 160 according to the input power distribution information corresponding to the stored amount and the power consumption amount of the load device 150.

As the present invention is mainly intended to prevent rise in power charges due to peak power when multiple load devices 150 are used, the present invention causes the produced power and the stored power as well as the commercial power to be appropriately used at the time when such peak power is generated and in the hours for which power consumption soars as a result of driving multiple load devices 150. Thereby, the present invention may implement optimized power control to reduce the electric power charge.

The power may be controlled in various ways depending on the amount of gas stored and the amount of power consumed. The power distribution information, which is important information for power control, includes operation information for storing the produced power of the power generation unit 130 in the power storage unit 140 as well as the start time and duration of selection of the commercial power, the produced power of the power generation unit 130, and the stored power of the power storage unit 140 selected as power to be supplied to the load devices 150.

The power distribution information is generated according to the stored amount and the power consumption of the load device 150 through a predetermined algorithm. For example, since the gas compressors 151 are operated according to change in the stored amount in the gas storage unit 110, the power generation unit 130 may be operated in consideration of the stored amount and the changed amount and the produced power and the stored power may be supplied in an appropriate ratio according to the power consumption amount before the peak power is generated by operation of the multiple gas compressors 151, such that the peak power is reduced. In addition, when the power consumption is low, the produced surplus power is stored in the power storage unit 140.

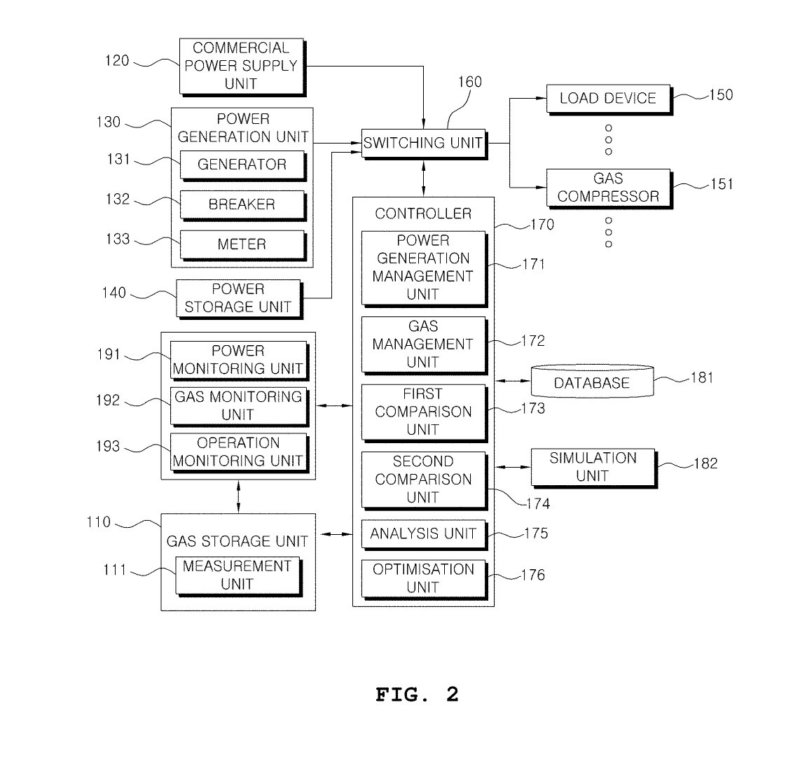

FIG. 2 is a block diagram illustrating a configuration and a connection relationship according to another embodiment of the present invention. The basic configuration of this embodiment is the same as the preferred embodiment illustrated in FIG. 1, but this embodiment further includes a preferred algorithm for generating power distribution information and relevant elements. Detailed description of the same contents as those described above will be omitted in order to avoid obscuring the main points in the following description.

In this embodiment, the power generation unit 130 includes an internal combustion engine generator 131 for generating electric power by burning gas, a breaker 132 for supplying the power generated by the generator 131 to the outside, and a meter 133 for calculating the amount of gas supplied to the generator 131.

The generator 131, which is a typical internal combustion engine generator, may receive a gas supplied as a fuel from the gas storage unit 110 and collect the amount of supplied gas through the meter 133. The breaker 132 is a kind of switch used to apply power generated by the generator 131 to loads. A typical example of the breaker 132 may be an air circuit breaker (ACB). If the breaker 132 does not operate, the generator 131 performs a no-load operation even if the generator 131 operates to generate electric power. If the breaker 132 operates, the generator 131 performs a load operation, increasing the amount of consumed fuel.

In another embodiment of the present invention, a power monitoring unit 191, a gas monitoring unit 192 and an operation monitoring unit 193 are provided to analyze specific parameters collected from the system for efficient efficient regulation of electric power to perform optimized control for cost reduction. These units are equipped with various sensors to monitor various operation values collected during operation of the corresponding elements.

The power monitoring unit 191 is configured to monitor the amount of power consumed by the load device 150, the amount of power generated by the power generation unit 130, and the amount of power stored in the power storage unit 140. The power monitoring unit 191 not only checks the stop and load or no-load operation state of the power generation unit 130, but also monitors produced electric power and the amount of applied load, i.e. power, the charge-discharge status and the amount of power stored in the power storage unit 140, the operation state and the number of the load devices 150, i.e., the gas chargers, and the loads in a comprehensive manner.

The gas monitoring unit 192 is configured to monitor the amount of gas supplied to the power generation unit 130 and the amount of storage and amount of change of the gas storage unit 110 measured through the measurement unit 111. The gas monitoring unit 192 collects the amount of supplied gas through the meter 133 provided in the power generation unit 130 and collects and monitors the amount of the remaining gas and the amount of change through the measurement unit 111 installed in the gas storage unit 110.

The operation monitoring unit 193 is configured to monitor the operation statuses of the power generation unit 130, the load device 150 and the switching unit 160. The operation monitoring unit 193 comprehensively monitors whether the generator 131 operates, how many load devices 150, namely, gas compressors 151 operate, whether the load devices are in the load operation mode or the no-load operation mode, and which route is taken to transmit power through the switching unit 160.

In a preferred embodiment of the present invention, the controller 170 includes a power generation management unit 171, a gas management unit 172, a first comparison unit 173, a second comparison unit 174, an analysis unit 175, and an optimization unit, and is provided with a database 181 and a simulation unit 182 as separate elements.

The power generation management unit 171 is configured to control the power generation unit 130. The internal combustion engine generator 131 having a complex system such as a cooling system, a fuel system, and a lubrication system is unlikely to produce/supply electric power while being immediately activated from the idle state when peak power is generated due to sudden increase in electric power consumption. When a compact generator is used in a small facility, the time from the idle state to the production/supply of electric power is somewhat shortened. However, since the gas compressor 151 of the gas refill center has a very high load, the capacity of the breaker 132 increases. Accordingly, the breaker 132 is operated in the state of no load operation when necessary before the power input is required, such that the power can be supplied. In this case, the operation timing of the breaker 132 considering synchronization with the commercial power is also important. In other words, stable power supply is possible only when the operation of the breaker 132 is performed with the voltage, phase, frequency, and waveform matched between the commercial power and the produced power of the generator 131.

The power generation monitoring unit 171 analyzes the monitoring result of the power monitoring unit 191, reflecting the above description. Thereby, when the amount of power consumption reaches a first set value, namely, before the peak power is generated, the power generation monitoring unit 171 generates startup information for the no-load driving of the generator 131 and the operation of the breaker 132. When power consumption reaches a second set value, the power generation management unit 171 may control the generator 131 and the breaker 132 according to the startup information such that power supply is performed at an appropriate timing.

On the contrary, when the power consumption is sufficiently low and the amount of stored power of the power storage unit 140 is large and thus no recharging is required, the power generation management unit 171 may control the breaker 132 and the generator 131 to perform the no-load operation and stop for a predetermined time.

The gas management unit 172 is configured to individually control the load devices 150, particularly, the plurality of gas compressors 151. Basically, in both a case where the gas compressors 151 are manually operated when gas transfer is required and a case where the gas compressors 151 are automatically operated to secure a storage amount of the gas storage unit 110, the gas compressors 151 are operated solely or in parallel at the gas refill center. As described above, when a plurality of gas compressors 151 are simultaneously driven, a large peak power is generated, and accordingly the gas management unit analyzes the amount of storage and the amount of change of the gas storage unit 110, which are major factors causing the gas compressors 151 to be driven. That is, when the change rate, namely, the decrease rate, is low, only the gas compressor 151 operates, but in case of a sudden decrease in the stored amount, two or more gas compressors 151 may be operated in parallel to compensate for the decrease. Separately, operation of another gas compressor 151 may be required for transfer of the gas to another place that demands gas. In order to prevent simultaneous operation of the gas compressors 151, the gas compressors 151 are pre-assigned priorities, and the gas management unit 172 generates sequential drive information on the plurality of gas compressors 151 in accordance with the priorities. Then, in a situation where multiple gas compressors 151 are to be operated, the gas management unit 172 sequentially operates the gas compressors.

The first comparison unit 173, the second comparison unit 174 and the analysis unit 175 are configured for a representative algorithm for generating power distribution information. The first comparator 173 compares the power consumption with the produced power of the power generator 130, and the second comparator 174 compares the amount of power consumption with the stored power of the power storage unit 130.

In the comparison results of the first comparator 173 and the second comparator 174, if the produced power of the power generator 130 is higher than the power consumption status, the analysis unit 175 generates power distribution information so as to store the surplus power in the power storage unit 140. If the power consumption status is higher than the stored power of the power storage unit 140, the analysis unit 175 generates power distribution information so as to supply commercial power to the load. Thereby, the controller 170 controls the switching unit 160 through the generated power distribution information, implementing efficient power management.

The database 181 is built by pre-storing power consumption information according to the capacity of the power storage unit 140 and the load and power cost information according to a power usage pattern and time for operation of the load devices 150.

The simulation unit 182 is configured to calculate a power charge for each situation by reflecting the results of monitoring of the power monitoring unit 191 and the operation monitoring unit 193 and the stored information of the database 181. Since charges are substantially added to commercial electric power, electric power charges are calculated based on the electric power consumption status and the usage time as well as the unit price pre-stored for calculating the added charges based on the currently supplied commercial electric power.

At this time, situation-specific charges are not calculated at random. With the current operation statues of the power generation unit 130, the load device 150 and the switching unit 160 reflected, the electric power charge is calculated by setting up a situation reflecting a future situation in which the switching unit 160 and the power generation unit 130 are controllable, based on the stored amount of the power storage unit 140 relative to the total capacity of the power storage unit 140, the reduction in the stored amount corresponding to the load devices 150 being operated, and the power usage pattern information according to the load devices 150 being operated.

Lastly, an optimization unit 176 provided in the controller 170 reflects the situation-specific electric charges calculated by the simulation unit 182 in generating power distribution information, such that the power charge can be minimized and that the control unit 130 and the switching unit 160 are controlled appropriately.

Hereinafter, a method for efficient regulation of electric power of a gas refill center according to the present invention will be described. It is assumed that the method for efficient regulation of electric power described below can be basically implemented through the system for efficient regulation of electric power described above. Detailed description of the same contents as those described above will be omitted.

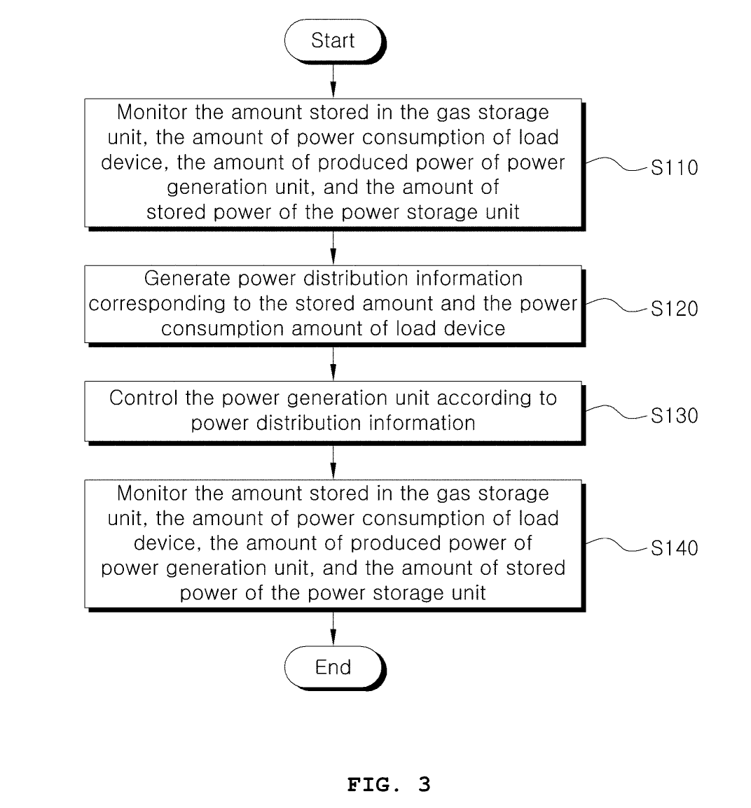

FIG. 3 is a flowchart illustrating a method for efficient regulation of electric power according to a preferred embodiment of the present invention.

First, in a first step S110, the amount of storage of the gas storage unit 110, the power consumption of the load devices 150 and the amount of produced power of the power generation unit 130, and the amount of the stored power of the power storage unit 140 are monitored through various sensors provided together with the respective elements.

Then, in a second step S120, power distribution information corresponding to the amount of storage and the power consumption amount of the load devices 150 is generated. The power distribution information, which is important information for power control, includes operation information for storing the produced power of the power generation unit 130 in the power storage unit 140 as well as the start time and duration of selection of the commercial power, the produced power of the power generation unit 130, and the stored power of the power storage unit 140 selected as power to be supplied to the load devices 150.

The power distribution information is generated according to the stored amount and the power consumption of the load device 150 through a predetermined algorithm. For example, since the gas compressors 151 are operated according to change in the stored amount in the gas storage unit 110, the power generation unit 130 may be operated in consideration of the stored amount and the changed amount and the produced power and the stored power may be supplied in an appropriate ratio according to the power consumption amount before the peak power is generated by operation of the multiple gas compressors 151, such that the peak power is reduced. In addition, when the power consumption is low, the produced surplus power is stored in the power storage unit 140.

In a third step S130, the power generation unit 130 is controlled according to the power distribution information. The power generation unit 130 includes an internal combustion engine generator 131 for generating electric power by burning gas, a breaker 132 for supplying the power generated by the generator 131 to the outside, and a meter 133 for calculating the amount of gas supplied to the generator 131. The generator 131 can perform no-load operation or load operation through the operation of the breaker 132.

In a fourth step S140, the commercial power, the produced power of the power generation unit 130, and the stored power of the power storage unit 140 are selectively supplied to the load devices 150 according to the power distribution information. That is, as the present invention is mainly intended to prevent rise in power charges due to peak power when multiple load devices 150 are used, the present invention causes the produced power and the stored power as well as the commercial power to be appropriately used at the time when such peak power is generated and in the hours for which power consumption soars as a result of driving multiple load devices 150. Thereby, the present invention may implement optimized power control to reduce the electric power charge.

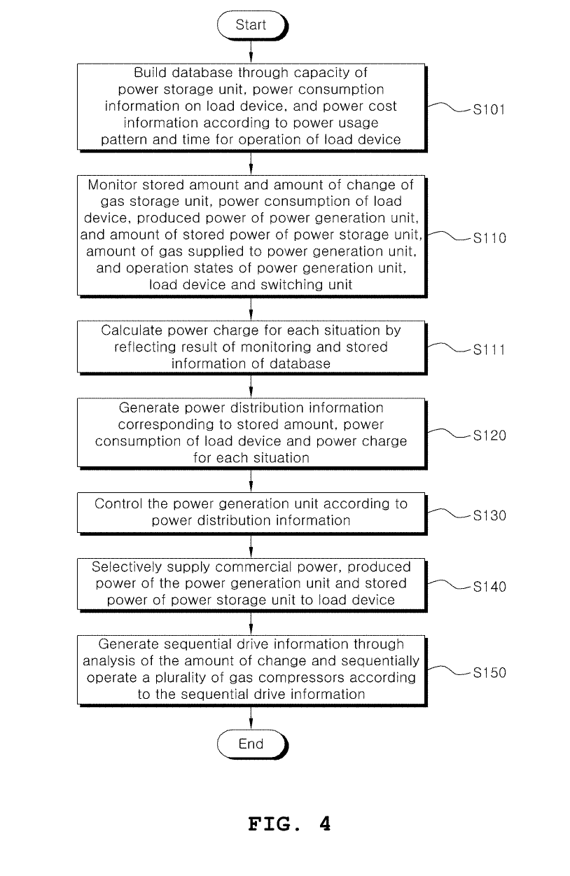

FIG. 4 is a flowchart illustrating a method for efficient regulation of electric power according to another embodiment of the present invention. The basic procedure of this embodiment is the same as the preferred embodiment described with reference to FIG. 3, but this embodiment further includes a more specific algorithm for generating power distribution information and a procedure for the same.

In another embodiment of the present invention, the step S130 of controlling the power generation unit 130 includes generating startup information for no-load driving of the power generation unit 130 and the operation of the breaker 132 by analyzing the result of the monitoring step S110 and controlling the generator 131 and the breaker 132 according to the startup information.

For example, when the power consumption reaches a first set value, namely, before the peak power is generated, start information for the no-load driving of the generator 131 and the operation of the breaker 132 is generated by analyzing the monitoring result. When the power consumption reaches a second set value, the generator 131 and the breaker 132 may be controlled according to the startup information such that the power supply is performed at an appropriate timing.

The monitoring step S110 may further include monitoring the amount of gas supplied to the power generation unit 130 and the amount of storage and amount of change of the gas storage unit, and the operation statuses of the power generation unit 130, the load device 150 and the switching unit 160. As well as monitoring the operating status of the system. That is, the amount of supplied gas is collected through the meter 133 provided in the power generation unit 130, and the amount of the remaining gas and the amount of change are collected through the measurement unit 111 installed in the gas storage unit 110. It is comprehensively monitored whether the generator 131 operates, how many load devices 150, namely, gas compressors 151 operate, whether the load devices are in the load operation mode or the no-load operation mode, and which route is taken to transmit power through the switching unit 160.

Thereafter, in a fifth step S150, sequential drive information on the plurality of gas compressors 151 is generated through analysis of the amount of change, and the gas compressors are sequentially operated according to the sequential drive information.

That is, as described above, when a plurality of gas compressors 151 are driven simultaneously, a large peak power is generated. Accordingly, the gas management unit analyzes the amount of storage and the amount of change of the gas storage unit 110, which are major factors causing the gas compressors 151 to be driven. In addition, in order to prevent simultaneous operation of the gas compressors 151, the gas compressors 151 are pre-assigned priorities, and the gas management unit generates sequential drive information on the plurality of gas compressors 151 in accordance with the priorities. Then, in a situation where multiple gas compressors 151 are to be operated, the gas management unit sequentially operates the gas compressors.

In another embodiment of the present invention, a step S101 of building a database through the capacity of the power storage unit 140, the power consumption information of the load devices 150, and power cost information according to a power usage pattern and time for operation of the load devices 150 is included before the monitoring step S110. A step S111 of calculating a power charge for each situation by reflecting the result of the monitoring step S110 and the stored information of the database 181 is further included after the monitoring step S110.

Since charges are substantially added to commercial electric power, electric power charges are calculated based on the electric power consumption status and the usage time as well as the unit price pre-stored for calculating the added charges based on the currently supplied commercial electric power. At this time, situation-specific charges are not calculated at random. With the current operation statues of the power generation unit 130, the load device 150 and the switching unit 160 reflected, the electric power charge is calculated by setting up a situation reflecting a future situation in which the switching unit 160 and the power generation unit 130 are controllable, based on the stored amount of the power storage unit 140 relative to the total capacity of the power storage unit 140, the reduction in the stored amount corresponding to the load devices 150 being operated, and the power usage pattern information according to the load devices 150 being operated.

Thereafter, in step S120 of generating the power destruction information, power distribution information is generated by reflecting the calculated situation-specific electric charges such that the electricity fee can be minimized.

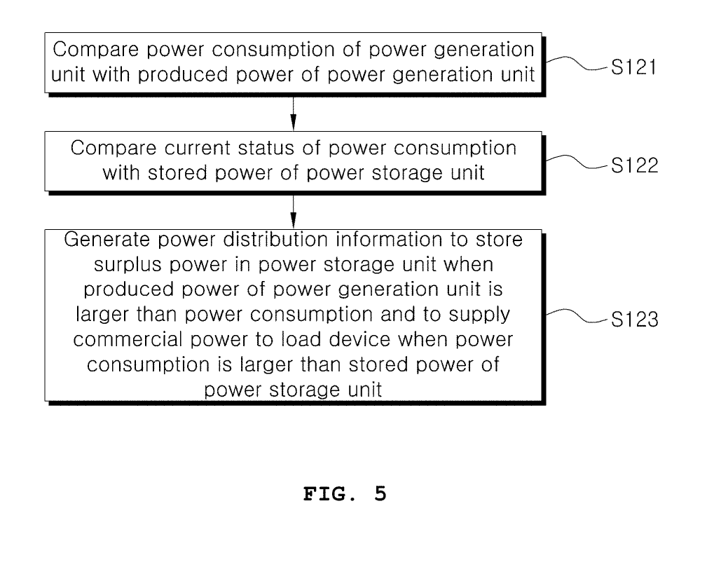

FIG. 5 is a flowchart illustrating the step of generating power distribution information according to another embodiment of the present invention.

In another embodiment of the present invention, the step S120 of generating the power distribution information may include the step S121 of comparing the amount of power consumption with the produced power of the power generation unit 130, the step S122 of comparing the current status of the power consumption with the stored power of the power storage unit 140, and the step S123 of generating power distribution information to store the surplus power in the power storage unit 140 when the produced power of the power generation unit exceeds the power consumption and generating power distribution information to supply the commercial power to the load devices 150 when the amount of power consumption is larger than the stored power of the power storage unit 140. Accordingly, efficient power management may be implemented by processing the generated power distribution information.

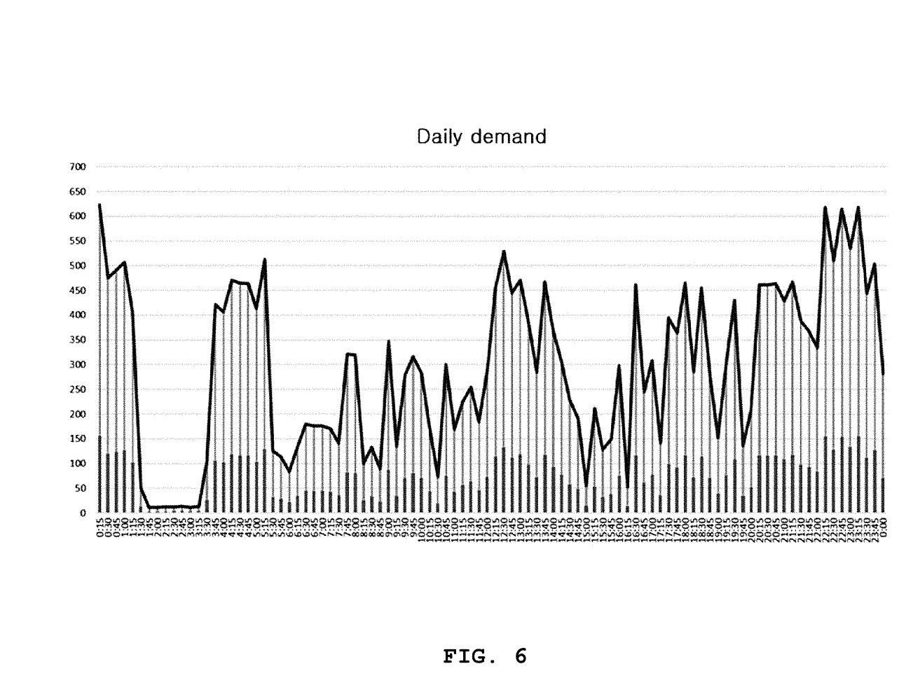

Hereinafter, power consumption trends before and after application of the system and method for efficient regulation of electric power described above to an actual site will be described with reference to FIGS. 6 to 9.

FIG. 6 is a graph depicting an example of a power usage trend of a gas refill center according to a unit time, wherein the vertical axis (y-axis) represents the power consumption amount and the horizontal axis (x-axis) represents a time lapse in units of 15 minutes for a day. The green bar indicates the amount of actual usage, the gray bar indicates the peak amount, and the red broken line indicates the maximum capacity. It can be seen from the figure that multiple peak powers are generated during one day depending on the number of gas chargers driven for charging and transferring the gas.

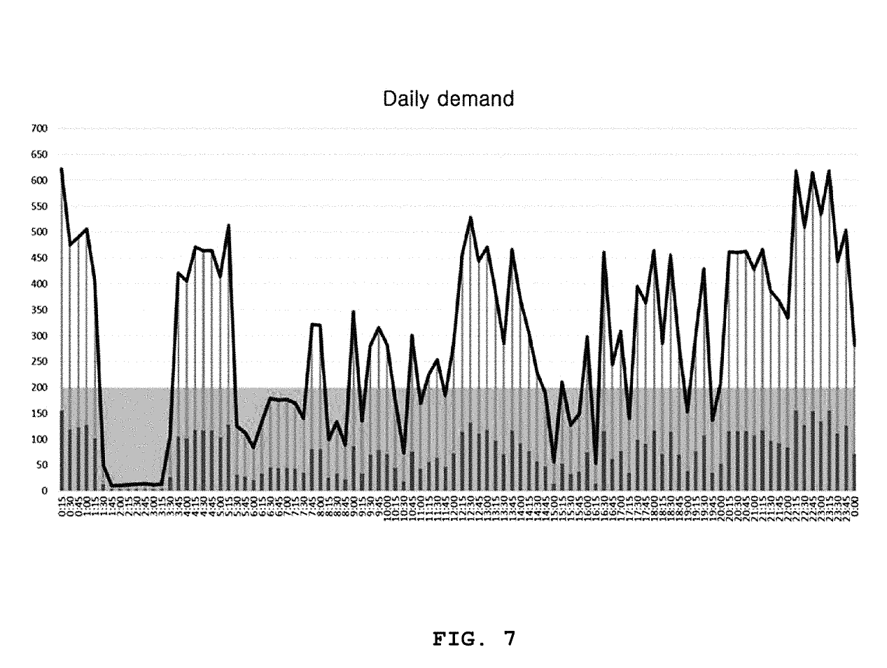

FIG. 7 is a graph depicting a power usage trend including 100% self-generated power, wherein the yellow part represents the amount of power that can be produced through the power generation unit 120. The power produced in this manner can cover a certain portion of the maximum capacity according to the peak power. However, since the power consumption of the load is lower than the produced power in a specific time zone, excess power may be generated. In this case, the excess power is preferably controlled to be stored in the power storage unit 130.

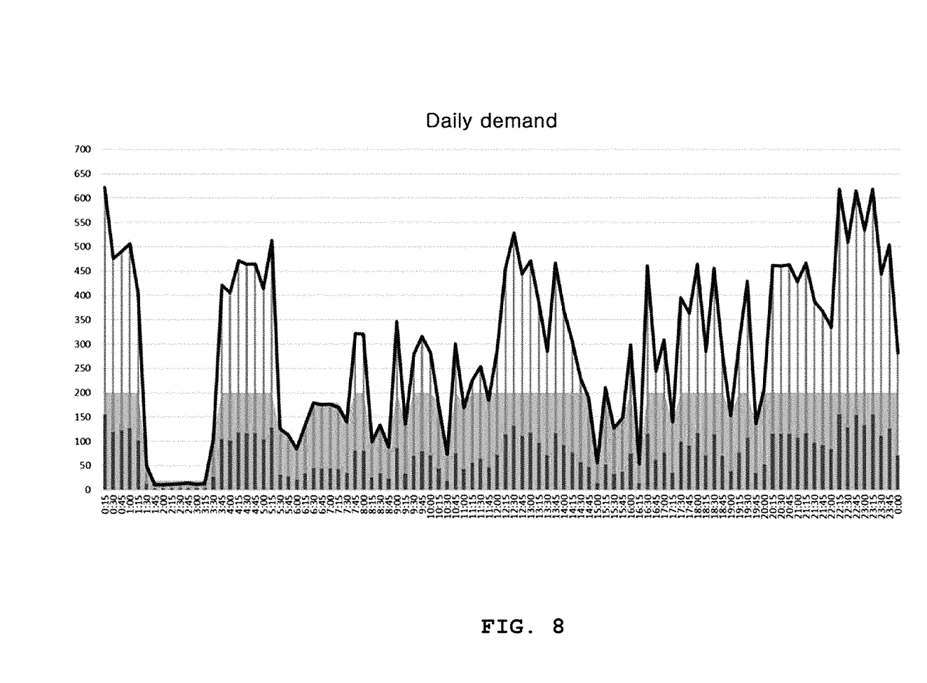

FIG. 8 is a graph depicting a power usage trend due to economic self-power generation reflecting variations in the load. In this case, the power generation unit 120 is operated in order to prevent excess power from being generated in an interval in which power consumption of the load is lower than the produced power as in the example of FIG. 7, and the produced power is supplied only when a high peak power is generated.

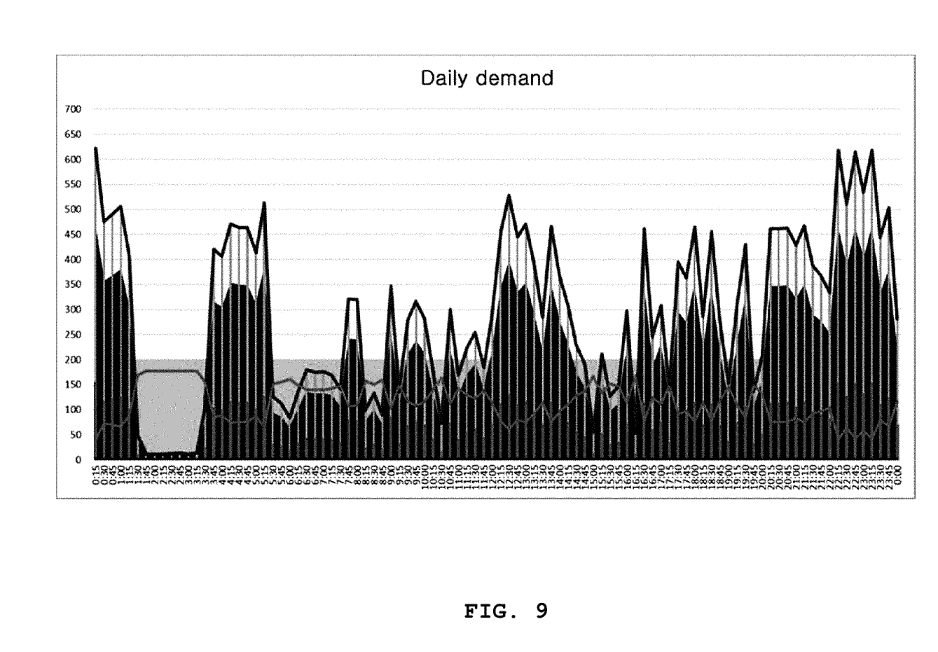

FIG. 9 is a graph depicting a trend of reduction in the amount of commercial power consumption according to application of the present invention. In FIG. 9, the green broken line indicates the stored amount of the power storage unit 130. It can be seen from the figure that the power storage is performed when the power usage of the load is lower than the produced power, and power discharging is performed in a region where power consumption is high.

The blue part indicates consumption of commercial power. In particular, when the peak power is high due to high power consumption of the load, the produced power and the stored power are appropriately used. Therefore, compared with the case where the commercial power is supplied alone, significant cost savings may be achieved.

As is apparent from the above description, according to embodiments of the present invention, when high-load devices are operated at the same time, it is possible to reduce the usage amount and the peak of the commercial power to reduce the excessive electricity usage fee, and to reduce the operation cost of the equipment even in the hours of demanding high electricity use and high power consumption. In addition, even if the commercial power supply is temporarily stopped or a power failure occurs due to a problem in the supply system, the self-power supply can be maintained for a certain time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for efficient regulation of electric power of a gas refill center having a plurality of load devices, the system comprising:
a measurement unit for measuring a stored amount of the gas storage unit;
a commercial power supply unit supplied with commercial power;
a power generation unit for producing electric power through gas;
a power storage unit for storing the produced power of the power generation unit;
a switching unit for selectively supplying the commercial power, the produced power of the power generation unit and the stored power of the power storage unit to the load device;
a controller configured to control the power generation unit, the load devices and the switching unit, the controller controlling the power generation unit and the switching unit according to input power distribution information corresponding to the stored amount and power consumption of the load device.

2. The system according to claim 1, further comprising:
a power monitoring unit for monitoring the power consumption of the load device, the produced power of the power generation unit, and an amount of the stored power of the power storage unit,
wherein the power generation unit comprises an internal combustion engine generator for generating electric power by burning gas, a breaker for supplying the power generated by the generator to an outside, and a meter for calculating an amount of gas supplied to the generator,
wherein the controller comprises a power generation management unit for analyzing a result of monitoring of the power monitoring unit to generate startup information for no-load driving of the generator and operation of the breaker and control the generator and the breaker according to the startup information.

3. The system according to claim 2, further comprising:
a gas monitoring unit for monitoring monitor an amount of gas supplied to the power generation unit and the stored amount and an amount of change of the gas storage unit,
wherein the controller comprises a gas management unit for generating sequential drive information on the plurality of gas compressors through analysis of the amount of change and sequentially operating the plurality of gas compressors according to the sequential drive information.

4. The system according to claim 2, wherein the controller further comprises:
a first comparison unit for comparing the power consumption with the produced power of the power generation unit, a second comparison unit for comparing a current status of the power consumption with the stored power of the power storage unit, and an analysis unit for generating power distribution information to store surplus power in the power storage unit when the produced power of the power generation unit is larger than the power consumption and to supply the commercial power to the load device when the power consumption is larger than the stored power of the power storage unit.

5. The system according to claim 2, further comprising:
an operation monitoring unit for monitoring operation states of the power generation unit, the load device and the switching unit;
a database for storing a capacity of the power storage unit, power consumption information on the load device, and power cost information according to a power usage pattern and time for operation of the load device;
a simulation unit for calculating a power charge for each situation by reflecting the result of monitoring of the power monitoring unit, a result of monitoring of the operation monitoring unit and the stored information of the database.

6. The system according to claim 5, wherein the controller further comprises an optimization unit for generating power distribution information by reflecting the power charge for each situation calculated by the simulation unit so as to minimize the power charge.

7. A method for efficient regulation of electric power of a gas refill center performed through an efficient power regulation system of the gas refill center, the method comprising:
monitoring a stored amount of a gas storage unit, power consumption of a load device, a produced power of a power generation unit, and an amount of a stored power of a power storage unit (S110);
generating power distribution information corresponding to the stored amount and the power consumption of the load device (S120);
controlling the power generation unit according to the power distribution information (S130); and
selectively supplying a commercial power, the produced power of the power generation unit and the stored power of the power storage unit to the load device (S140).

8. The method according to claim 7, wherein the controlling of the power generation unit (S130) comprises:
generating startup information for no-load driving of the power generation unit and operation of a breaker by analyzing a result of the monitoring (S110) and controlling a generator and the breaker according to the startup information.

9. The method according to claim 7, wherein the monitoring (S110) comprises:
monitoring an amount of gas supplied to the power generation unit, the stored amount and an amount of change of the gas storage unit,
the method further comprising:
generating sequential drive information on a plurality of gas compressors through analysis of the amount of change and sequentially operating the plurality of gas compressors according to the sequential drive information (S150).

10. The method according to claim 7, the generating of the power distribution information (S120) comprises:
comparing the power consumption with the produced power of the power generation unit (S121);
comparing a current status of the power consumption with the stored power of the power storage unit (S122); and
generating power distribution information to store surplus power in the power storage unit when the produced power of the power generation unit is larger than the power consumption and to supply the commercial power to the load device when the power consumption is larger than the stored power of the power storage unit (S123).

11. The method according to claim 7, wherein the monitoring (S110) comprises:
monitoring operation states of the power generation unit, the load device, and a switching unit,
the method further comprising:
building a database through a capacity of the power storage unit, power consumption information on the load device, and power cost information according to a power usage pattern and time for operation of the load device (S101); and
calculating a power charge for each situation by reflecting a result of the monitoring (S110) and stored information of the database (S111),
wherein the generating of the power distribution information generating (S120) comprises generating the power distribution information by reflecting the calculated power charge for each situation such that the power charge is minimized.
